(19) United States
(12) Patent Application Publication
(10) Pub. No.: US 2014/0231608 A1
(43) Pub. Date: Aug. 21, 2014

(54) Adjustable Beverage Holder

(71) Applicant: Timothy Aldor Fontaine, Kuna, ID (US)

(72) Inventor: Timothy Aldor Fontaine, Kuna, ID (US)

(21) Appl. No.: 14/174,225

(22) Filed: Mar. 14, 2014

(51) Int. Cl. A47K 1/09; F16M 13/02; A47G 23/02

(52) U.S. Cl. CPC A47K 1/09; A47G 23/0208; F16M 13/022
USPC 248/311.2

(57) ABSTRACT

A beverage holder for receiving vessels which includes a coupling device capable of being attached to flat horizontal surfaces such as, but not limited to, bleacher seats, tables and lawn chairs. The beverage holding device has a cylindrical shaped “cup” or “Basket” that allows the user to place a beverage container of varying types and sizes inside.

### BACKGROUND OF THE DISCLOSURE

a) Field of the Invention

The invention relates to an apparatus removably attached to a solid horizontal surface such as, but not limited to; bleacher seating, tables and lawn chairs for the purpose of holding beverages, food and similar concessions.

b) Background Art

The invention relates to the art of beverage holders that generally are attached to seats for the purpose of holding beverages, food and similar concessions.

The purchase and consumption of beverages at sporting events has become as much a part of the overall experience as the sport itself. When said beverages are brought back to the seating area they are often placed upon the floor. At times, the only other reasonable option is to hold the beverage in hand until it is completely consumed. While some stadium seating has been adapted with built-in beverage holders, there are many which have not. Thus, the need is clear for a portable beverage holder that can be brought with the sports fan or purchased at the stadium, brought home and then reused at other sporting events and venues.

### SUMMARY OF THE DISCLOSURE

The disclosed embodiment is a vessel holder to be used in stadium seating, tables, lawn chairs and any other horizontal flat surface where such holders have not already been adapted or are not sufficient for use. The disclosure is useful for holding beverage containers, snacks and the like which are commonly found at stadiums, sporting events, concerts, picnics, BBQ's and kitchens.

### BRIEF DESCRIPTION OF THE DRAWINGS

FIG. 1 is a front view of the beverage holder

FIG. 2 is a view from the top of the beverage holder

FIG. 3 is a view from the side of the beverage holder

FIG. 4 is a view from the bottom of the beverage holder

FIG. 5 is a view from the back of the beverage holder

FIG. 6 is a view from above angling downward of the beverage holder

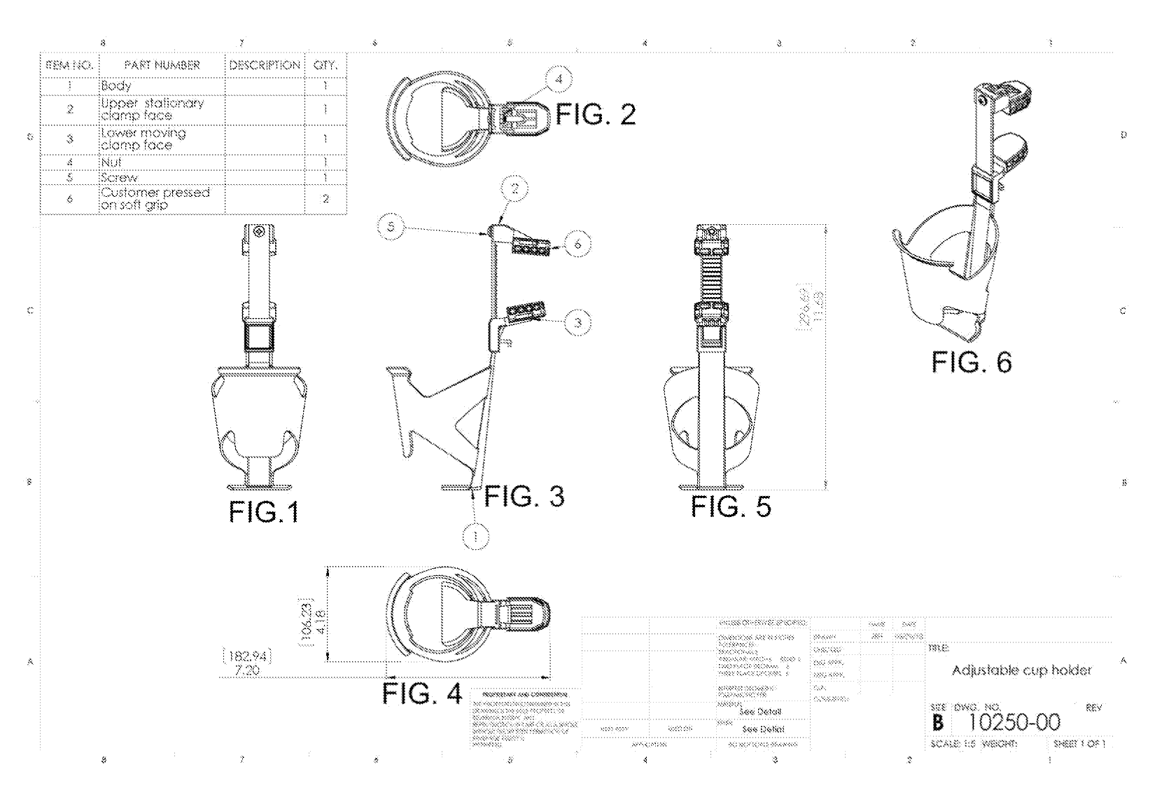

### DESCRIPTION OF THE PREFERRED EMBODIMENTS

FIG. 3 Shows the side view of the apparatus in one form and shows the bottom portion of the beverage holder which the bottom 1 of the vessel is placed and held. As further shown in FIG. 3 the Lower Moving Clamp Face 3 moves vertically up and down upon the body of the beverage holder in order that it may be clamped to a flat horizontal surface and thereby coupling the apparatus to the desired surface. As further shown in FIG. 3 the Upper Stationary Clamp Face 2 remains stationary and is place on top of a flat horizontal surface as the beverage holder is coupled to that surface.

Again referring to FIG. 3, both the Lower Moving Clamp Face 3 and Upper Stationary Clamp Face 2 are covered by Soft Grip Sleeves 6 for the purpose of gripping that surface of which it is being coupled. Further, the Upper Stationary Clamp Face 2 is affixed to the body of the beverage holder via a Screw 5 and Nut 4.

To use the apparatus, the Lower Moving Clamp Face 3 is unlocked and moved towards the bottom of the beverage holder so as to sufficiently to open up the “jaws” of the unit, the “jaws” are then positioned on top and bottom of the surface to be coupled between the Lower Moving Clamp Face 3 and the Upper Stationary Clamp Face 2, the Lower Moving Clamp Face 3 is slid in and upward direction and positioned snugly against the bottom of the surface to be coupled and finally the locking mechanism is operated in order to assure the apparatus remains stationary. To increase the capacity to stay coupled to a selected surface the backside of the body of the apparatus is ribbed in such as manner to allow the Lower Moving Clamp Face 3 to lock into a specific groove or ribbed indentation. When the Lower Moving Clamp Face 3 is locked into place the locking mechanism enters one of the indentations and remains there until unlocked.

As with any mass produced article, space is always a part of the cost of sales and storage. As shown in FIG. 3 is the beverage holder is stackable one inside of the other and thereby efficient in its use of space.

While the present invention is illustrated by description of several embodiments and while the illustrative embodiments are described in detail, it is not the intention of the patent applicant to restrict or, in any way, limit the scope of the appended

claims to such detail. Additional advantages and modifications within the scope of the appended claims will be readily apparent to those sufficient in the art. The invention in its broader aspects is therefore not limited to the specific details, representative apparatus, methods, and illustrative examples shown and described. Accordingly, departures may be made from such details without departing from the spirit or scope of the applicant's general concept.

### SUMMARY OF THE INVENTION

The invented beverage holder is designed for use with an upright cup, can or bottle. The holder is in turn designed for holding hot or cold liquids, and has an open rim and base.

The invented beverage holder is formed from a preformed mold that is subsequently filled with plastic. The four molded parts are removed from said mold then subsequently assembled to form the whole unit.

The parts consist of the body, the Upper Stationary Clamp Face 1, the Lower Moving Clamp Face 3, a Screw 5 and a Nut 4 and two Soft Grips 6 that are attached to the both the Upper Stationary Clamp Face 2 and Lower Moving Clamp Face 3. The clamping faces are utilized for attaching the beverage holder to a solid surface while the Soft Grips 6 provide traction to the clamp faces in order for them to adhere to the desired position.

The plastic is molded with a flat vertical spine that runs the length of the unit which is flat on the front side and ribbed on the backside and a “cup” designed to hold beverage containers.

The holder includes a texture to increase the ability to grip the beverage holder in the hands of the user.

1. A vessel holder removably coupled to a horizontal surface such as a bleacher, table or other surface, wherein the vessel holder comprises:
a. a rigid basket which supports the weight of the vessel and liquid herein, defined by a molded plastic designed to support and hold multiple types of beverage containers,
b. a surface mounting portion including an upper (stationary) and lower (moving) face clamp fastened to the basket and configured to be coupled to and extend beyond the edge of a flat horizontal surface,
c. a retaining structure coupled to the surface mounting portion coupled to the first side of the surface mounting portion and configured to extend under the bottom and top of the flat horizontal surface, wherein the basket, upper stationary face clamp and lower face clamp are assembled to be utilized as a unitary structure, where in both the upper and lower face clamps have pressed on soft grip devices.

2. The vessel holder of claim 1, wherein the bleacher seat, table or said coupled surface is either stationary or mobile apparatus.

3. The vessel holder of claim 1, wherein the upper clamp, lower clamp and basket are assembled to comprise a unitary structure.

4. The vessel holder of claim 1, further comprising:
a. a rigid basket support integrally formed with and extending between the basket and the surface mounting portion, the rigid basket support configured to stabilize the basket.

5. The vessel holder of claim 1, wherein the basket includes an outer surface and inner surface being sized such that when one vessel holder is stacked on top of a second vessel holder, the out surface of the basket of the first vessel holder nests closely against the inner surface of the basket of the second vessel holder.

6. The vessel holder of claim 1, wherein the front portion of the opening of the basket has an outwardly projecting lip strengthening the vessel holder at the opening.
